(19) United States
(12) Patent Application Publication
(10) Pub. No.: US 2010/0309401 A1
(43) Pub. Date: Dec. 9, 2010

(54) LIQUID CRYSTAL DISPLAY DEVICE AND METHOD FOR MANUFACTURING THE SAME

(75) Inventor: Shin MORITA, Ishikawa-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toshiba Mobile Display Co., Ltd., Tokyo (JP)

(21) Appl. No.: 12/649,772

(22) Filed: Dec. 30, 2009

(30) Foreign Application Priority Data
Jun. 3, 2009 (JP) 2009-134340

(51) Int. Cl. G02F 1/1343; G02F 1/1333; G02F 1/13

(52) U.S. Cl. 349/54; 349/139; 349/192

(57) ABSTRACT

A liquid crystal display device includes a plurality of pixels arranged near intersections between signal lines and scan lines in a matrix to form a display area. The scan lines and signal lines extend in a row and a column directions of the pixels in the display area. A first conductive layer is arranged on an insulating substrate. A second conductive layer is arranged on the first conductive layer through an insulating layer. The second conductive layer is electrically connected to the signal line. The first conductive layer includes an opposite region opposite to the second conductive layer and is arranged to surround the display area. The opposite region includes a cut out portion in which a disconnected scan line is repaired by irradiating the cut out portion with laser.

### CROSS-REFERENCE TO RELATED APPLICATION

This application is based upon and claims the benefit of priority from prior Japanese Patent Application No. 2009-134340, filed Jun. 3, 2009, and the entire contents of which are incorporated herein by reference.

### BACKGROUND OF THE INVENTION

1. Field of the Invention

The present invention relates to a liquid crystal display device, and more particularly to an active matrix type liquid crystal display device capable of repairing defect portions of the display device in a manufacturing process.

2. Description of the Related Art

Liquid crystal display device includes an array substrate, a counter substrate opposite to the array substrate and a liquid crystal layer held between the substrates. The liquid crystal display device is formed through such steps as an array process to form the array substrate, a cell process to hold the array substrate and the counter substrate so as to face each other and to inject liquid crystal material between the substrates, and a module process to build driving circuits and control circuit boards in the liquid crystal display device. Conventionally, a Japanese laid open patent application 2008-268860 proposes a liquid crystal display device, in which the occurrence of probability of electrode destroy due to static electricity is reduced and the destroyed electrodes by the static electricity are repaired several times in a manufacturing process.

The array process includes some manufacturing processes such as a thin film forming process to form a plurality of conductive layers and insulating layers, plasma and wet etching processes, and other various manufacturing processes. In the array process, foreign substances may mix which results in defects of a film pattern and further bright spots, dark spots and wiring disconnections.

In the array manufacturing process, when defective portions as described-above are found, the defective portions are repaired by irradiating with laser or laser CVD after forming a plurality of conductive layers and insulating layers. Further, though the defective portions are not found at the array process, the defective portions may be found in the lighting inspection during the cell process. In such a case, the defective portions are repaired by disturbing an alignment of the liquid crystal molecules or by reforming the contact portions by irradiating laser from an insulating substrate side in the array substrate.

However, it may be difficult to repair by disturbing the alignment of the liquid crystal molecule depending on the liquid crystal materials or a utilized alignment mode. Further, when the contact portions are repaired, the residual substance thing may disperse into the cell. When the size of the residual substance thing turns into a size near the gap between the array substrate and the counter substrate, short-circuit with the array substrate and the counter substrate may be caused due to the residual substance thing, which may result in further defects.

### BRIEF SUMMARY OF THE INVENTION

The present invention has been made to address the above-mentioned problems. One object of this invention is to provide a liquid crystal display device capable of reducing a generation of further defects by repairing the defective portions generated in the manufacturing process and raising a production yield.

Thus, according to one aspect of the invention, there is provided a liquid crystal display device including: a first substrate formed of an insulating substrate and a second substrates arranged opposite to the first substrate; a liquid crystal layer held between the first and second substrates; a display area including a plurality of pixels arranged in a matrix; a first conductive layer arranged on the insulating substrate to surround the display area; a second conductive layer arranged on the first conductive layer through a first insulating layer; scan lines extending in a row direction of the pixels in the display area; and signal lines extending in a column direction of the pixels in the display area, and wherein the first conductive layer includes an opposite region opposite to the second conductive layer and a cut out portion formed in the opposite region.

According to another aspect of the invention, there is provided a method for manufacturing a liquid crystal display device including a display area having a plurality of pixels arranged in a matrix, including: arranging scan lines extending in a row direction of the pixels in the display area and signal lines extending in a column direction of the pixels in the display area; forming a first conductive layer arranged on an insulating substrate; forming a second conductive layer arranged on the first conductive layer through an insulating layer, the second conductive layer being electrically connected to the signal line; forming an opposite region in the first conductive layer opposite to the second conductive layer so as to surround the display area; and forming a cut out portion in the opposite region, and wherein one of the signal lines is disconnected and the opposite regions arranged at both ends of the disconnected signal line are irradiated with laser to connect the repair wiring layer and the both ends of the disconnected signal line.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a structure of a liquid crystal display device according to a first embodiment of the present invention.

FIG. 2 is a plan view showing a cross area where a repair wiring layer and a signal line layer cross in the liquid crystal display device shown in FIG. 1 according to the first embodiment.

FIG. 3 is a cross-sectional view showing the cross area shown in FIG. 2 taken along line III-III according to the first embodiment of the present invention.

FIG. 4 is a plan view showing a cross area where the repair wiring layer and the signal line layer cross in the liquid crystal display device shown in FIG. 1 according to a second embodiment.

FIG. 5 is a plan view showing a cross area where the repair wiring layer and the signal line layer cross in the liquid crystal display device shown in FIG. 1 according to a third embodiment.

FIG. 6 is a cross-sectional view showing the cross area shown in FIG. 5 taken along line VI-VI according to the third embodiment of the present invention.

FIG. 7 is a block diagram showing a structure of a liquid crystal display device according to a fourth embodiment of the present invention.

FIG. 8 is a plan view showing a cross area where the repair wiring layer and the scan line layer cross in the liquid crystal display device shown in FIG. 7 according to the fourth embodiment.

FIG. 9 is a cross-sectional view showing the cross area shown in FIG. 8 taken along line V-V according to the fourth embodiment of the present invention.

FIG. 10 is a plan view showing a cross area where the repair wiring layer and the scan line layer cross in the liquid crystal display device shown in FIG. 7 according to a fifth embodiment.

FIG. 11 is a block diagram showing a structure of a liquid crystal display device according to a sixth embodiment of the present invention.

### DETAILED DESCRIPTION OF THE INVENTION

A liquid crystal display device, and more particularly to an active matrix type liquid crystal display device capable of repairing defect portions of the display device in a manufacturing process will now be described with reference to the accompanying drawings wherein the same or like reference numerals designate the same or corresponding parts throughout the several views.

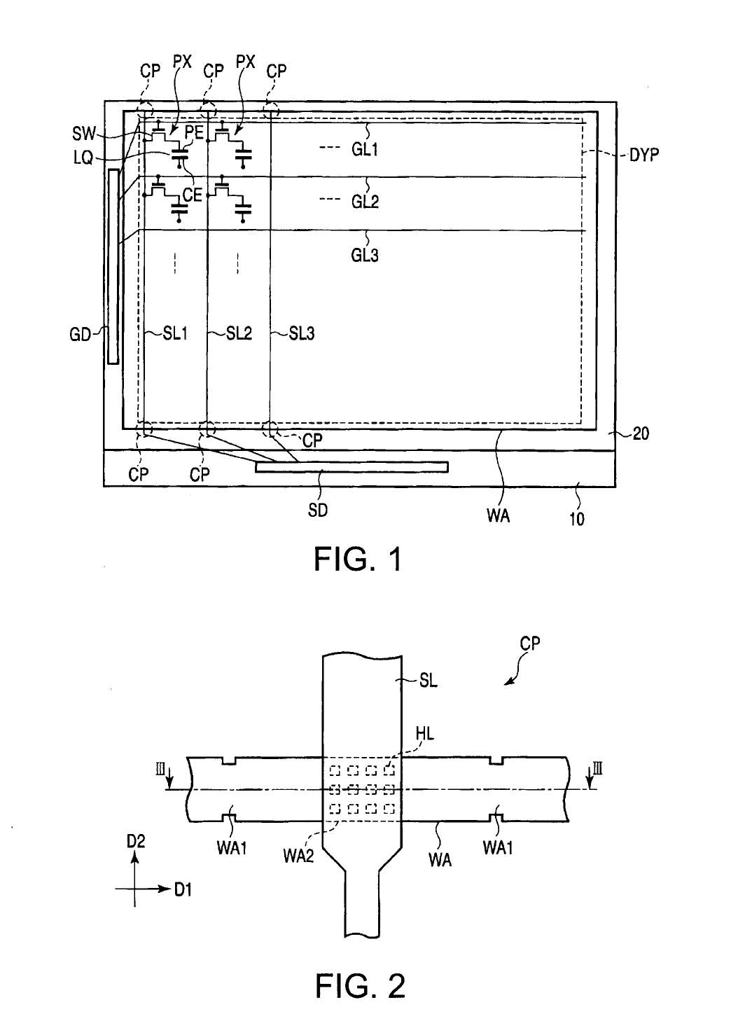

FIG. 1 is a block diagram showing a structure of a liquid crystal display device according to a first embodiment of the present invention. The liquid crystal display device according to the first embodiment includes an array substrate (first substrate) 10, a counter substrate 20 (second substrate) opposite to the array substrate 10, a liquid crystal layer LQ held between the array substrate 10 and the counter substrate 20 and a display area DYP formed of a plurality of pixels PX arranged in a matrix.

The array substrate 10 includes pixel electrodes PE coupled to respective pixels PX, a plurality of scan lines GL (GL1, GL2, GL3, . . . ) arranged along pixels PX in a row direction and signal lines SL (SL1, SL2, SL3, . . . ) arranged along pixels in a column direction and pixel switches SW arranged near intersections where the scan lines GL and the signal lines SL cross. Respective pixel switches SW include thin film transistors (TFTs) as switching elements. Respective gate electrodes of the TFTs are connected to associated scan lines GL or integrally formed with the scan lines GL. Respective source electrodes of the TFTs are connected to associated signal lines SL or integrally formed with the signal lines SL.

The scan lines GL are connected to a scan line driving circuit GD arranged at a peripheral of a display area DYP. Similarly, the signal lines SL are connected to a signal line driving circuit SD arranged at other peripheral of the display area DYP. The scan line driving circuit GD sequentially drives the plurality of scan lines GL based on control signals supplied from a control device (not shown). When gate voltages (scan line driving signals) are applied to the TFTs by the selected scan lines GL, source-drain path of the TFTs are conductive. The signal line driving circuit SD supplies image signals to the plurality of signal lines SL in parallel. Consequently, the image signals supplied to the plurality of scan lines SL are applied to respective pixel electrodes PE from the associated signal lines SL.

The counter substrate 20 includes a counter electrode CE opposite to the plurality of pixel electrodes PE. Counter voltage is supplied to the counter electrode CE by a counter electrode driving circuit (not shown). A pair of alignment films (not shown) is formed on both surfaces of the pixel electrodes PE and the counter electrode CE. Rubbing treatment in a predetermined direction is conducted on the surfaces of the alignment films.

An initial alignment direction of the liquid crystal molecules contained in the liquid crystal layer LQ is controlled by a rubbing direction. The alignment condition of the liquid crystal layer LQ is controlled by potential difference between the pixel electrode PE and the counter electrode CE. According to this embodiment, the array substrate 10 includes a repair wiring WA formed of a first conductive layer that surrounds the peripheral of the display area DYP. The repair wiring WA is formed along a first longitudinal edge of the liquid crystal display panel in which the signal driving circuit SD is formed and a second longitudinal edge opposite to the first longitudinal edge on an insulating substrate SB1. The repair wiring WA along the first and second longitudinal edges is connected with the repair wiring WA along a first and a second narrow edges of the liquid crystal display panel so as to surround the display area DYP. In this embodiment, signal lines SL correspond to a second conductive layer.

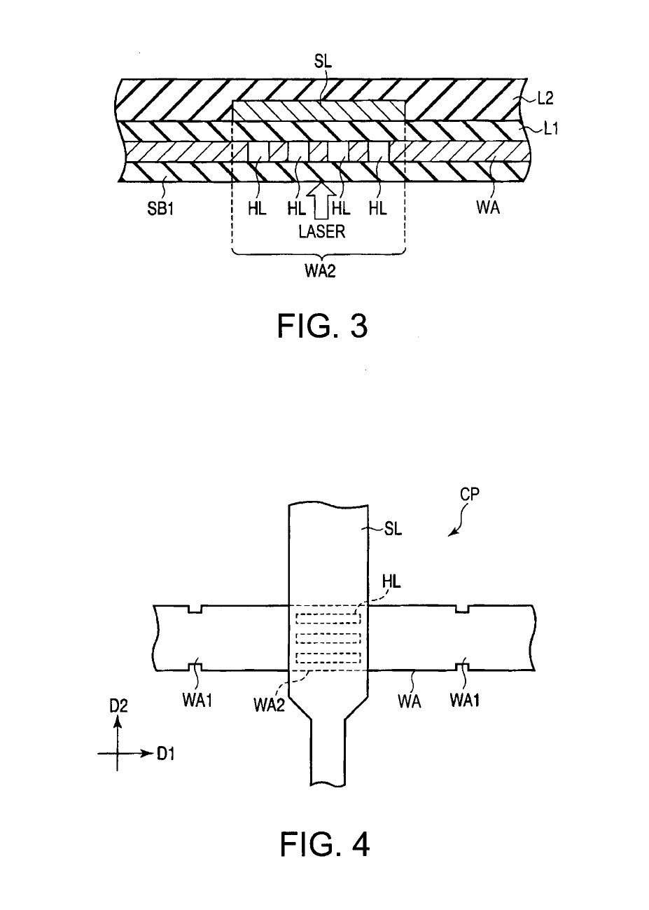

FIG. 2 is a plan view showing a cross area where the repair wiring layer and the signal line layer cross in the liquid crystal display device shown in FIG. 1 according to the first embodiment. FIG. 3 is a cross-sectional view showing the cross area shown in FIG. 2 taken along line III-III according to the first embodiment. The repair wiring layer WA crosses with the scan line layer SL at cross areas CP through an insulating layer L1 and opposite to the signal line layer SL. The repair wiring layer WA is located on the downside of the signal line layer SL. The repair wiring layer WA includes opposite regions WA2 in which the repair wiring layer WA opposes to the signal line layers SL through an insulating layer L1. Each of the opposite regions WA2 includes a cut out portion HL. In this embodiment shown in FIGS. 2 and 3, four holes in a horizontal direction D1 (row direction) in which the repair wiring layer WA extends and three holes in which the repair wiring layer WA extends in a vertical direction D2 (column direction) with respect to the direction D1 are formed in a matrix.

In this embodiment, the cut out portion HL is formed of a plurality of holes made in the opposite region WA2 of the repair wiring WA and the plan shape of the hole is square but may be circle or polygonal. Moreover, the cut out portion HL does not necessarily penetrate to the insulating substrate SB1 and a concavity shape may be adopted.

The repair wiring layer WA includes narrow wiring portions WA1 provided at both sides of the opposite region WA2. When the repair wiring layer WA includes a plurality of opposite regions WA2 in which the repair wiring layer WA opposes to the plurality of signal line layers SL, the narrow wiring portions WA1 are arranged at both sides of the respective opposite regions WA2. The width of the narrow wiring portions WA1 in the direction D2 is smaller than other portions. In this embodiment, when at least one of the signal line layers SL is disconnected at inside of the display area DYP, the repair wiring layer WA is connected with the disconnected signal line layer SL at the first and second longitudinal edge sides of the repair wiring WA through the cross areas CP. Consequently, the disconnected signal line layer SL is repaired by using a detoured repair wiring layer WA extending to the second longitudinal edge side from the first longitudinal edge side of the display panel in which the signal line driver circuit SD is formed.

When a disconnection of the signal line layer SL is found in a light-on inspection after injecting the liquid crystal material into the attached array substrate 10 and the counter substrate 20, the repair wiring layer WA is contacted with the signal line layer SL by irradiating the opposite region WA2 from the insulating substrate SB1 with laser in the array substrate 10. In this case, if the area of the opposite region WA2 in the repairing wiring layer WA to be irradiated with laser is large, laser irradiation with high power is required, which may result in affecting unnecessary irradiation to peripheral portions. That is, if laser irradiation with large power is conducted, the residual wiring materials of the repair wiring layer WA may disperse into the liquid crystal layer LQ and disturb the alignment of the liquid crystal layer LQ. In the case where the size of the dispersed residual material is large, the dispersed residual material may result in short-circuit between the array substrate 10 and the counter substrate 20. Therefore, the cut out portion HL in the repair wiring layer WA are arranged to make the opposite areas WA2 small, which are irradiated with small power laser in this embodiment.

Accordingly, it becomes possible to irradiate the opposite areas WA2 arranged close to the insulating substrate SB1 with low power laser from the insulating substrate SB1 in the array substrate 10. The repair wiring layer WA reliably contacts with the disconnected signal line layer SL Consequently, the disperse of the residual materials, which are generated around the opposite region WA2 affected by the irradiation of laser, into the liquid crystal layer LQ is avoided and further generation of the defects due to the repairing process is suppressed.

Moreover, one of the two narrow wiring portions WA1 arranged at both sides of the opposite region WA2 is cut by irradiating with laser from the insulating substrate SB1 in the array substrate 10. Accordingly, only one bypass route from the first longitudinal edge side to the opposite second longitudinal edge side is formed by cutting one of the narrow wiring portions WA1. The disconnected signal line layer SL is repaired by connecting the both ends of the disconnected signal line layer SL with the repair wiring layer WA. Consequently, one bypass route is formed to repair the disconnected signal line SL.

On the other hand, another bypass route is used for repairing other disconnected signal line layer SL. After identifying the disconnected signal lines SL, it is necessary to cut one of the narrow wiring portions WA1 to prevent an increase of the parasitic capacitance due to the other bypass route even if the other bypass route is not used. When the residual materials generated in the cut narrow wiring portion WA1 disperses into the liquid crystal layer LQ, which may result in a short-circuit between the counter substrate 10 and the array substrate 20. In this case, since the repair wiring layer WA is cut at the narrow wiring portions WA1, it becomes possible to make the irradiating power of laser small and even if dispersed materials are generated, the size of the dispersed materials can be made small. Accordingly, the generation of the display panel defects due to the cutting of the repair wiring layer WA is suppressed.

As mentioned-above, when the signal line layers SL are disconnected, the disconnected signal line layers SL are connected with the repair wiring layer WA at the cross areas CP arranged at both ends of the signal line layers SL. The image signals outputted from the signal line driving circuit SD are supplied to both sides of the disconnected point of the signal line layer SL through a bypass route formed of the repair wiring layer WA.

According to this embodiment, the defects due to the disconnection of the signal line layers SL of the display panel is repaired without a generation of further defects in the repairing process, which results in raising the production yield.

FIG. 4 is a plan view showing a cross area CP where the repair wiring layer WA and the signal line layer SL cross in the liquid crystal display device shown in FIG. 1 according to the second embodiment. In this embodiment, the cut out portion HL is formed along the direction D1 of the repair wiring layer WA in a slit shape. The substantial area of the opposite region WA2 of the repair wiring layer WA, which faces the signal line layers SL through the insulating layer L1, is made small by forming the cut out portion HL to extend in the direction D1. Further, an increase of electrical resistance of the repair wiring layer WA is suppressed though the area of the opposite region WA2 is made small.

Further, a reinforcement layer (not shown), which includes at least one of a conductive layer and an insulating layer, may be formed on an insulating layer L2 arranged on the signal line layer SL. In this embodiment, the reinforcement layer formed of ITO (Indium Tin Oxide) is arranged on the insulating layer L2 at the cross areas CP. Owing to the reinforcement layer, even if dispersions of the laser power, and patterns of the signal line layers SL and repair wiring layer WA are generated, the dispersion of the residual materials generated in the repairing process into the liquid crystal layer LQ is suppressed.

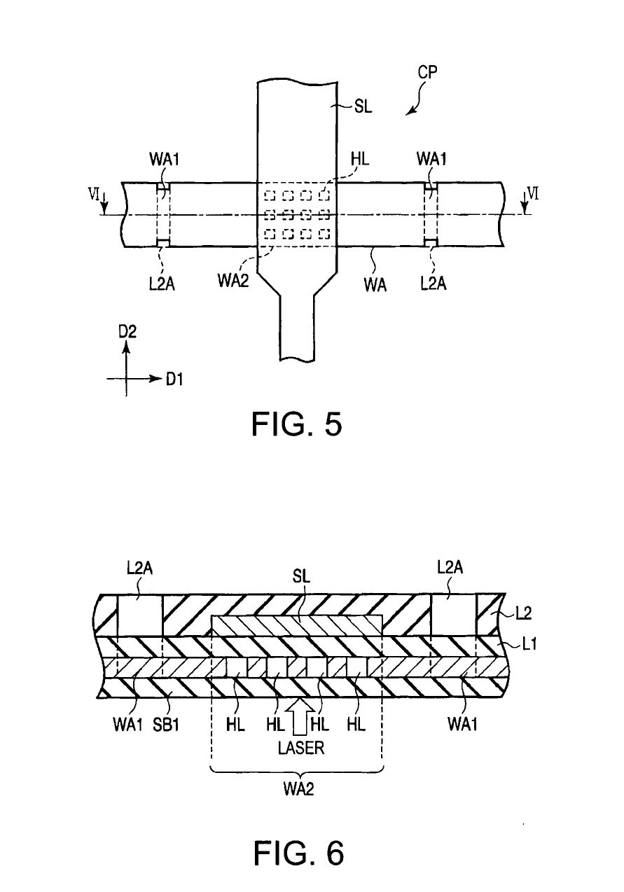

A third embodiment according to the present invention will be explained referring FIGS. 5 and 6. FIG. 5 is a plan view showing a cross area CP where a repair wiring WA and a signal line layer SL cross in the liquid crystal display device shown in FIG. 1. FIG. 6 is a cross-sectional view showing the cross area CP shown in FIG. 5 taken along line VI-VI.

As shown in FIGS. 5 and 6, a protection layer arranged on the repair wiring layer WA includes insulating layers L1 and L2. Thinner portions of the protection film are formed on the narrow wiring portions WA1. In this embodiment, cut out portions L2A are formed in the insulating layer L2 on the narrow wiring portions WA1 to make thinner portions. In this embodiment, when the repair wiring layer WA is cut at the narrow wiring portions WA1 by irradiating with laser from the insulating substrate SB1, the laser power is lowered. Further, since the protection film is formed thin and irradiated with lower power laser, the dispersion of the protection film into the liquid crystal layer LQ is suppressed.

According to this embodiment, not only the same effect as the first and second embodiments is obtained but the adverse affect by cutting the repair wiring layer WA at the narrow wiring portions WA1 is suppressed. That is, further generation of the defects in the repairing process is effectively suppressed and the production yield is raised.

In the above embodiment, though the thinner portion of the protection layer is formed of only the insulating layer L2 so as to penetrate to the insulating layer L1, it is possible to make the thinner portion without penetrating to the insulating layer L1. That is, a portion of the insulating layer L2 may be left in the thinner portion. Moreover, a portion of the insulating layer L1 may be thinned by combining the insulating layers L2 and L1 to make the thinner portion deeper using a half torn development process.

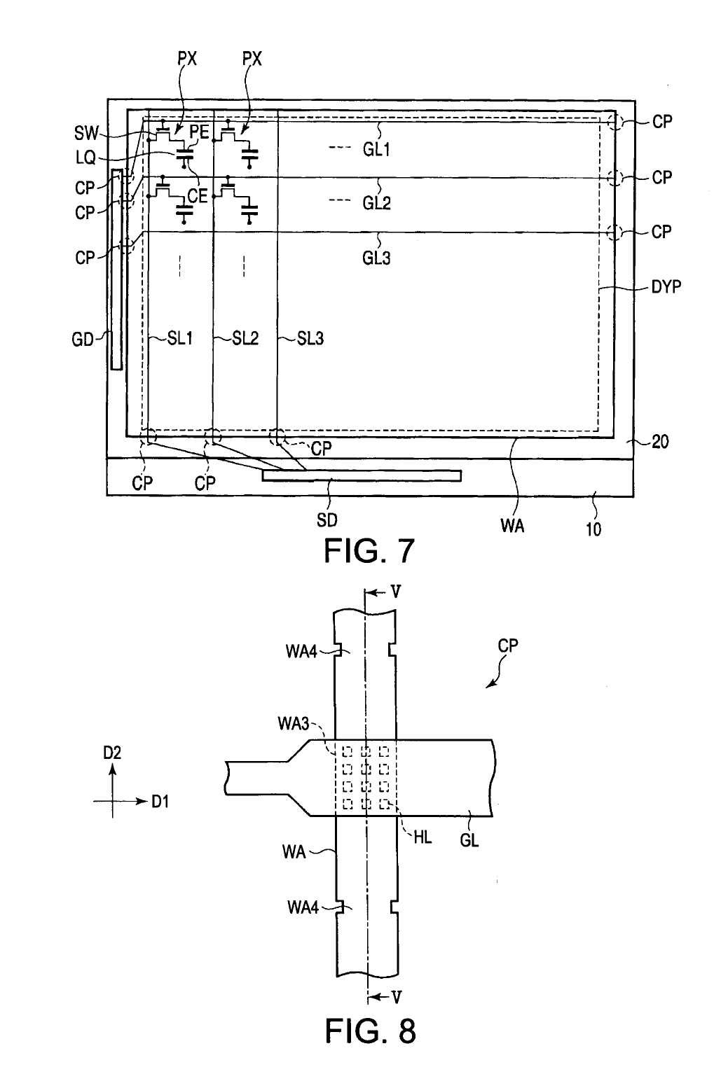

FIGS. 7, 8 and 9 show a fourth embodiment in which the scan line layers GL are repaired though the signal line layers SL are repaired in the first embodiment. According to this embodiment, the array substrate 10 includes a repair wiring layer WA formed of a first conductive layer surrounding the display area DYP as well as the first embodiment. The repair wiring layer WA is formed along a first narrow edge of the liquid crystal display panel in which the scan driving circuit GD is formed and a second narrow edge opposite to the first narrow side edge on an insulating substrate SB1. The repair wiring layer WA arranged along the first and second narrow edges are connected with the repair wiring layer WA arranged along the first and second longitudinal edges to surround the display area DYP. In this embodiment, the scan line layer GL corresponds to the second conductive layer.

FIG. 8 is a plan view showing a cross area CP where the repair wiring layer WA and scan line layer GL cross in the liquid crystal display panel shown in FIG. 7. FIG. 9 is a cross-sectional view showing the cross area CP shown in FIG. 7 taken along line V-V. The repair wiring layer WA crosses with scan line layer GL at cross area CP on the insulating layer L1 and opposite to the scan line layer GL. The repair wiring layer WA is located on the downside of the scan line layer GL. The repair wiring layer WA includes opposite region WA 3 in which the repair wiring layer WA opposes to the scan line layer GL through an insulating layer L1. The opposite region WA3 includes a cut out portion HL. In this embodiment shown in FIGS. 7 and 8, four holes in a direction D2 (column direction) in which the repair wiring layer WA vertically extends and three holes in the horizontal direction D1 (row direction) with respect to the direction D2 are formed in a matrix.

The repair wiring layer WA includes narrow wiring portions WA4 arranged at both sides of the opposite region WA3. When the repair wiring layer WA includes a plurality of opposite regions WA3 in which the opposite regions WA3 oppose to the plurality of scan line layers GL, the narrow wiring portions WA4 are arranged between adjacent opposite regions WA3. The width of the narrow wiring portion WA4 in the direction D1 is smaller than other portions. In this embodiment, when the scan line layers GL are disconnected at inside of the display area DYP, the repair wiring layer WA is connected with the disconnected scan line layers GL at the first and second narrow edges of the display panel through cross areas CP. Consequently, the disconnected scan line layers GL are repaired by a detoured repair wiring layer WA extending to the second narrow edge from the first narrow edge in which the scan driving circuit GD is formed.

When a disconnection of the scan line layer GL is found in a light-on inspection after injecting the liquid crystal material into the attached array substrate 10 and the counter substrate 20, the repair wiring layer WA is contacted with the scan line layer GL by irradiating the opposite region WA3 with laser from the insulating substrate SB1 in the array substrate 10. A cut out portion HL in the opposite region WA3 are made to make the opposite region WA3 small, which is irradiated with laser in this embodiment. Accordingly, it becomes possible to irradiate the opposite region WA3 arranged close to the insulating substrate SB1 with low power laser from the insulating substrate SB1 in the array substrate 10. The repair wiring layer WA reliably contacts with the scan line layer GL. Consequently, the dispersion of the residual materials into the liquid crystal layer LQ, which are generated at around the opposite region WA3 is avoided and further generation of the defects due to the repairing process is suppressed.

Moreover, one of the two narrow wiring portions WA4 arranged at both sides of the opposite region WA3 is cut by irradiating with laser from the insulating substrate SB1 in the array substrate 10. Accordingly, only one bypass route from the first narrow side to the opposite second narrow side is formed by cutting one of the narrow wiring portions WA4. The disconnected scan line layer GL is repaired by connecting the both ends of the disconnected scan line layer GL with the repair wiring layer WA using one bypass route. On the other hand, another bypass route is used for repairing other disconnected scan line layer GL. After identifying the disconnected scan line layer GL, it is necessary to cut one of the narrow wiring portions WA4 to prevent an increase of the parasitic capacitance due to the other bypass route. When the residual materials of the cut narrow wiring portions WA4 disperse into the liquid crystal layer LQ, a short circuit may be generated between the array substrate 10 and the counter substrate 20 in the display panel. In this case, since the repair wiring layer WA is cut at the narrow wiring portions WA4, it becomes possible to make the irradiating power small. Further, even if residual materials are generated, the size of the dispersed material can be made small. Accordingly, the generation of the defects of the display panel due to the cutting of the repair wiring layer WA is prevented.

As mentioned-above, when the scan line layers GL are disconnected, the disconnected scan line layers GL are connected with the repair wiring layer WA at the cross areas CP arranged at both ends of the scan line layers GL. The scan signals outputted from the scan line driving circuit GD are supplied to both sides of disconnected point through the repair wiring layer WA.

According to this embodiment, the defects due to the disconnection of the scan line layers GL are repaired without a generation of further defects in the repairing process, which results in raising the production yield.

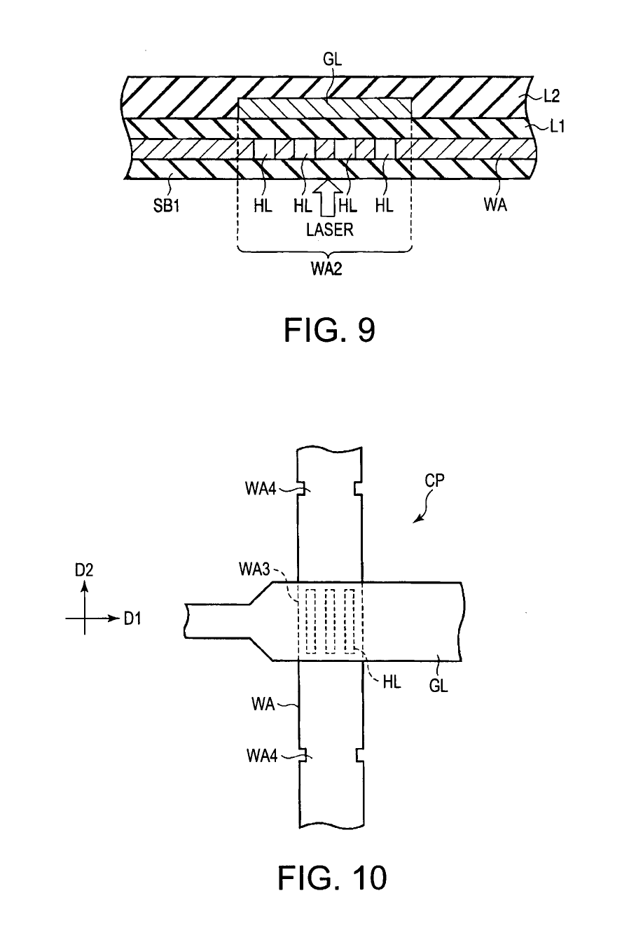

FIG. 10 is a plan view showing a cross area where a repair wiring layer and a scan line layer cross in the liquid crystal display device shown in FIG. 7 according to the fifth embodiment. In this embodiment, the cut out portion HL includes a plurality of slits formed in the opposite region WA3 of the repair wiring layer WA and extending in the direction D2. The substantial area of the opposite region WA3 of the repair wiring layer WA, which faces the scan line layer GL through the insulating layer L1, is made small by forming the cut out portion HL to extend in the direction D2. Further, an increase of electrical resistance of the repair wiring WA is prevented. In this embodiment, thinner portions may be formed in a protection layer having insulating layers L1 and L2 to avoid dispersion of residual materials into the liquid crystal layer when laser is irradiated to cut the repair wiring layer WA as well as the third embodiment.

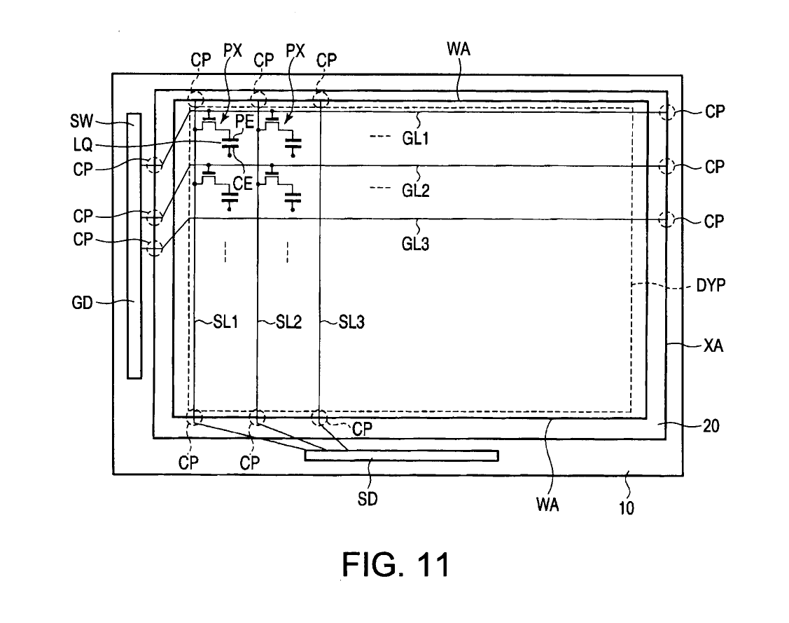

FIG. 11 shows a sixth embodiment in which both signal line layers SL and scan line layers GL are repaired. Two repair wiring layers WA and XA are formed to surround the display area DYP. Connections between respective repair wiring layers WA and XA and the signal and scan line layers SL and GL are described in the first and fourth embodiment shown in FIGS. 2 and 8. The signal line layers SL extend crossing the repair wirings layers WA and XA from the signal line driving circuit SD to opposite longitudinal edge side. Similarly, the scan line layers GL extend crossing the repair wirings WA and XA from the scan line driving circuit GD to the opposite narrow edge side.

When a signal line layer SL is disconnected at inside of the display area DYP, the repair wiring layer WA is connected with the disconnected scan line layer SL at the first and second longitudinal edge sides of the repair wiring layer WA through cross areas CP. Consequently, the disconnected signal line layer SL is repaired by using a detoured repair wiring layer WA extending to the second longitudinal edge from the first longitudinal edge of the display panel in which the signal driving circuit SD is formed. Similarly, when a scan line layer GL is disconnected at inside of the same display area DYP, the repair wiring layer XA is connected with the both ends of the disconnected scan line layer GL through the cross areas CP.

Consequently, the disconnected scan line layer GL is repaired by using the detoured repair wiring XA extending to the second narrow edge along the longitudinal edge from the first narrow edge of the display panel. Laser is irradiated to the respective opposite regions WA2 and WA3 of the signal repair wiring layer WA and the scan repair wiring layer XA. Consequently, both of the disconnected signal line layer SL and the disconnected scan line layer GL are repaired in the same display panel.

In this embodiment, the cut out portions HL are provided in the opposite regions WA2 and WA3 formed in the repair wiring layers WA and XA. The respective cut out portions HL include, for example, a plurality of holes arranged in a matrix or slits arranged in the direction where the repair wiring layers WA and XA extend as shown in FIGS. 4 and 10. Narrow wiring portions WA1 and WA4 are also arranged at both sides of the opposed regions WA2 and WA3. After being irradiated with laser, the repair wiring layers WA and XA are cut at one of the narrow wiring portions WA1 and WA4 arranged at both sides of the opposed regions WA2 and WA3. According to this embodiment, both signal line layers SL and scan line layers GL are repaired without resulting in further defects in the repairing process.

According to the present invention, there is provided a liquid crystal display device in which display defects by disconnection of the signal lines SL or scan lines GL are repaired and a further generation of the defects is suppressed in the repairing process. Accordingly, the production yield is also raised.

The present invention is not limited directly to the above described embodiments. In practice, the structural elements can be modified without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined. It is to be understood that within the scope of the appended claims, the present invention may be practiced other than as specifically disclosed.

What is claimed is:

1. A liquid crystal display device comprising:
a first substrate formed of an insulating substrate and a second substrates arranged opposite to the first substrate;
a liquid crystal layer held between the first and second substrates;
a display area including a plurality of pixels arranged in a matrix;
a first conductive layer arranged on the insulating substrate to surround the display area;
a second conductive layer arranged on the first conductive layer through a first insulating layer;
scan lines extending in a row direction of the pixels in the display area; and
signal lines extending in a column direction of the pixels in the display area, and
wherein the first conductive layer includes an opposite region opposite to the second conductive layer and a cut out portion formed in the opposite region.

2. The liquid crystal display device according to claim 1, wherein the cut out portion includes a plurality of holes formed in the opposite region in a row direction and a column direction in a matrix.

3. The liquid crystal display device according to claim 1, wherein the cut out portion includes a plurality of slits formed in the opposite region in a direction in which the first conductive layer extends.

4. The liquid crystal display device according to claim 1, wherein a reinforcement layer is arranged on the second conductive layer through a second insulating layer at near intersections in which the first and second conductive layers cross.

5. The liquid crystal display device according to claim 1, wherein the first conductive layer includes a narrow wiring portion in which a width of the first conductive layer is smaller than other portions.

6. The liquid crystal display device according to claim 5, wherein the liquid crystal display device further includes a second insulating layer forming a protection layer with the first insulating layer and the protection layer includes a thinner portion formed on the narrow wiring portion.

7. A liquid crystal display device comprising:
a first substrate formed of an insulating substrate and a second substrates arranged opposite to the first substrate;
a liquid crystal layer held between the first and second substrates;
a display area including a plurality of pixels arranged in a matrix;
a repair wiring layer arranged on the insulating substrate, the repair wiring layer surrounding the display area;
signal line layers arranged on the repair wiring layer through a first insulating layer and extending in a column direction of the pixels in the display area;
scan line layers extending in a row direction of the pixels in the display area; and
wherein the repair wiring layer includes an opposite region opposite to the signal line layer and a cut out portion formed in the repair wiring layer corresponding to the opposite region.

8. The liquid crystal display device according to claim 7, wherein the cut out portion includes a plurality of holes arranged in the row direction and in the column direction in a matrix.

9. The liquid crystal display device according to claim 7, wherein the cut out portion includes a plurality of slits formed in the repair wiring layer in a direction in which the repair wiring layer extends.

10. The liquid crystal display device according to claim 7, wherein a reinforcement layer is arranged on the signal line layers through a second insulating layer at near intersections in which the scan line layers and the repair wiring layer cross.

11. The liquid crystal display device according to claim 7, wherein the repair wiring layer includes a narrow wiring portion in which a width of the repair wiring layer in the column direction is smaller than other portions

12. The liquid crystal display device according to claim 11, wherein the liquid crystal display device further includes a second insulating layer forming a protection layer with the first insulating layer and the protection layer includes a thinner portion formed on the narrow wiring portion.

13. A liquid crystal display device comprising:
a first substrate formed of an insulating substrate and a second substrates arranged opposite to the first substrate;
a liquid crystal layer held between the first and second substrates;
a display area including a plurality of pixels arranged in a matrix;
a repair wiring layer arranged on the insulating substrate, the repair wiring layer surrounding the display area;
scan line layers arranged on the repair wiring layer through a first insulating layer and extending in a row direction of the pixels in the display area; and
signal line layers extending in a column direction of the pixels in the display area, and
wherein the repair wiring layer includes an opposite region opposite to the scan line layer and cut out portion formed in the repair wiring layer corresponding to the opposite region.

14. The liquid crystal display device according to claim 13, wherein the cut out portion includes a plurality of holes formed in the opposite region in the column direction and in the row direction in a matrix.

15. The liquid crystal display device according to claim 13, wherein the cut out portion includes a plurality of slits formed in the repair wiring layer in a direction in which the repair wiring layer extends.

16. The liquid crystal display device according to claim 13, wherein a reinforcement layer is arranged on the scan line layers through a second insulating layer at near intersections in which the scan line layers and the repair wiring layer cross.

17. The liquid crystal display device according to claim 13, wherein the repair wiring layer includes a narrow wiring portion in which a width of the repair wiring layer in the row direction is smaller than other portions, and
wherein the liquid crystal display device further includes a second insulating layer forming a protection layer with the first insulating layer and the protection layer includes a thinner portion formed on the narrow wiring portion.

18. A liquid crystal display device comprising:
a first substrate formed of an insulating substrate and a second substrates arranged opposite to the first substrate;
a liquid crystal layer held between the first and second substrates;
a display area including a plurality of pixels arranged in a matrix;
a first and a second repair wiring layers arranged on the insulating substrate, the first and second repair wiring layers surrounding the display area;
signal line layers arranged on the first and second repair wiring layers through an insulating layer and extending in a column direction of the pixels in the display area; and
scan line layers arranged on the first and second repair wiring layers through the insulating layer and extending in a row direction of the pixels in the display area, and
wherein the first repair wiring layer includes a first opposite region opposite to the signal line layer and a cut out portion formed in the first repair wiring layer corresponding to the first opposite region, and
wherein the second repair wiring layer includes a second opposite region opposite to the scan line layer and a cut out portion formed in the second repair wiring layer corresponding to the second opposite region.

19. A method for manufacturing a liquid crystal display device including a display area having a plurality of pixels arranged in a matrix, comprising:
arranging scan lines extending in a row direction of the pixels in the display area and signal lines extending in a column direction of the pixels in the display area;
forming a first conductive layer arranged on an insulating substrate;
forming a second conductive layer arranged on the first conductive layer through an insulating layer, the second conductive layer being electrically connected to the signal line; and
forming an opposite region in the first conductive layer opposite to the second conductive layer so as to surround the display area; and
forming a cut out portion in the opposite region, and
wherein one of the signal lines is disconnected and the opposite regions arranged at both ends of the disconnected signal line are irradiated with laser to connect the repair wiring layer and the both ends of the disconnected signal line.

20. The method for manufacturing a liquid crystal display device according to claim 19,
wherein the cut out portion includes a plurality of holes formed in a row direction and a column direction in a matrix, and
wherein the repair wiring layer includes a narrow wiring portion in which a width of the repair wiring layer in the column direction is smaller than other portions.
